(19) United States
(12) Patent Application Publication
(10) Pub. No.: US 2012/0160965 A1
(43) Pub. Date: Jun. 28, 2012

(54) METHOD TO ACHIEVE A RAPID AND LOW POWER SLEW OF A SATELLITE

(76) Inventor: Ronald M. Muller, Upper Marlboro, MD (US)

(21) Appl. No.: 12/977,397

(22) Filed: Dec. 23, 2010

(51) Int. Cl. B64G 1/28

(52) U.S. Cl. 244/165

(57) ABSTRACT

A method includes providing two or more momentum wheels arranged for rotation on a spacecraft in a momentum-canceling set. The method further includes causing the two or more momentum wheels in the momentum-canceling set to rotate at momentum-canceling speeds. Additionally, the method includes reducing rotational speed of a momentum wheel in the momentum-canceling set to initiate a slew of the spacecraft.

### BACKGROUND

1. Technical Field

The present invention relates generally to spacecraft slew, and more particularly, but not by way of limitation, to systems and methods for using momentum wheels to control spacecraft slew.

2. History Of Related Art

Oftentimes, a spacecraft such as, for example, a satellite, may have to be reoriented, for example, to point an attached telescope in a new direction. A term used to describe such reorientation is slew. For purposes of this patent application, slew refers to rotation of an object such as a spacecraft about an axis thereof. Momentum wheels driven by torque motors are often used to facilitate slew of a satellite or other spacecraft.

Prior art systems position, for example, one momentum wheel for rotation parallel to each of a pitch axis and a yaw axis of the satellite. Typically, motor torque is applied to a momentum wheel in order to cause rotation in one direction. The satellite responds by rotating in the opposite direction. For small slews, when the satellite is about halfway between an initial orientation and a desired orientation, the motor torque is reversed so as to slow the rotation of the momentum wheel. The satellite's response is to slow its slew and then stop at or near the desired orientation. Although the power driving the momentum wheel might be the maximum-rated power for the momentum wheel, for small slews, the momentum wheel often does not achieve its maximum-rated speed before having to slow down in order to stop the satellite at the desired orientation. In such cases, the speed of the slew is determined by the capability of the torque motor and the power available to drive the torque until braking is required.

An illustrative application of momentum wheels is a scientific satellite designed to rapidly view a short-term phenomenon such as, for example, a Gamma-ray burst. Gamma-ray bursts occur infrequently and randomly and can appear at any point of the sky. Typically, an all-sky Gamma-ray burst detector on the scientific satellite may detect a start of a gamma-ray burst and determine approximate coordinates. The gamma-ray burst may then be viewed with a telescope on the scientific satellite by slewing the scientific satellite to that approximate location in the sky. The telescope typically observes the gamma-ray burst as it progresses and more accurately determines its coordinates. However, during the time it takes for the scientific satellite to slew from its initial location to the gamma-ray burst's approximate location, valuable information could be lost.

### SUMMARY OF THE INVENTION

In one embodiment, a method includes providing two or more momentum wheels arranged for rotation on a spacecraft in a momentum-canceling set. The method further includes causing the two or more momentum wheels in the momentum-canceling set to rotate at momentum-canceling speeds. Additionally, the method includes reducing rotational speed of a momentum wheel in the momentum-canceling set to initiate a slew of the spacecraft.

In one embodiment, a momentum-wheel configuration for a spacecraft includes two or more momentum wheels. The two or more momentum wheels are arranged for rotation on the spacecraft in a momentum-canceling set.

The above summary of the invention is not intended to represent each embodiment or every aspect of the present invention.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates a spacecraft;

FIG. 2 illustrates a momentum-wheel configuration;

FIG. 3A shows an initial orientation of a spacecraft;

FIG. 3B shows an illustrative slew of a spacecraft;

FIG. 4 is a graph that shows slew time against slew angle; and

FIG. 5 is a graph that illustrates time required to achieve a 50-degree slew about one axis.

### DETAILED DESCRIPTION OF ILLUSTRATIVE EMBODIMENTS OF THE INVENTION

In various embodiments, a spacecraft such as, for example, a satellite, may be required to slew to a particular orientation so that, for example, a telescope can observe an event at a particular location in space. The event may be a sporadically-occurring event such as, for example, a Gamma-ray burst. Additionally, the slew may require rotation of the spacecraft about at least one axis of the spacecraft such as, for example, a yaw axis or a pitch axis. In various embodiments, causing momentum wheels to rotate in momentum-canceling sets prior to or in between slews of the spacecraft enables the spacecraft to more rapidly and more efficiently slew to a different orientation.

As used herein, a momentum-canceling set is an arrangement of momentum wheels in which rotation of any one momentum wheel in the momentum-canceling set may be at least partially offset by momentum generated via appropriate rotation of any other momentum wheel in the momentum-canceling set. This allows momentum to be stored in the momentum wheels of the momentum-canceling set. As explained below, in various embodiments, the stored momentum can be efficiently transferred to a spacecraft to effect slew.

The momentum wheels in a momentum-canceling set are operable to simultaneously rotate in a manner that endeavors to produce no net momentum by the momentum-canceling set. For example, momentum wheels in a particular momentum-canceling set may rotate at speeds that result in all momentum produced by the momentum wheels being canceled. In various embodiments, a momentum-wheel configuration on a spacecraft may include one or more momentum-canceling sets. Various advantages that may result from rotation of momentum wheels in momentum-canceling sets, including an ability to transfer stored momentum to a spacecraft, will be discussed in more detail below.

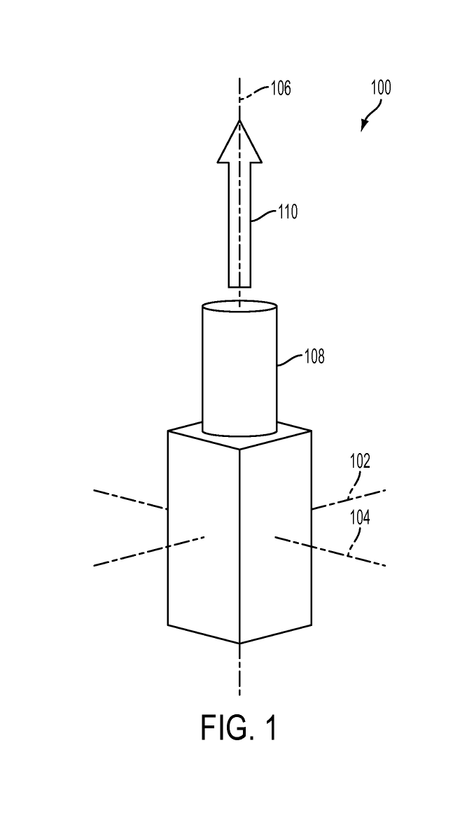

FIG. 1 illustrates a spacecraft 100 that may be, for example, a satellite. The spacecraft 100 may include, for example, a viewing device 108. The viewing device 108 has a line of sight 110. The viewing device 108 may be, for example, a telescope, camera, or other similar device. FIG. 1 illustrates a yaw axis 102, a pitch axis 104, and a roll axis 106. As one of ordinary skill in the art will appreciate, the yaw axis 102, the pitch axis 104, and the roll axis 106 are perpendicular to one another and are defined relative to a center of mass of the spacecraft 100.

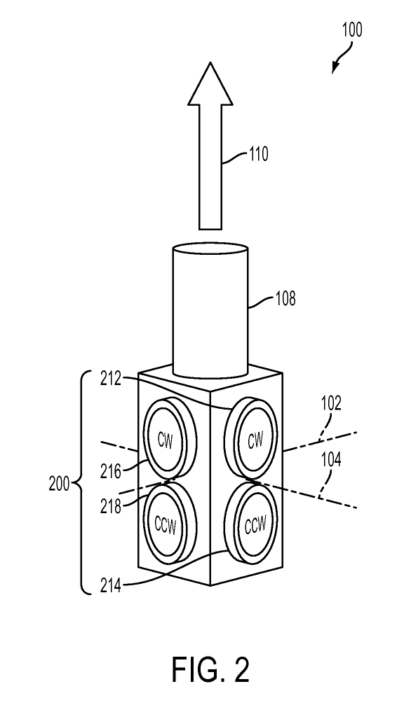

FIG. 2 shows an illustrative momentum-wheel configuration 200. Momentum wheels 212 and 214 are shown oriented for rotation on axes parallel to the pitch axis 104. Momentum wheels 216 and 218 are shown oriented for rotation on axes parallel to the yaw axis 102. The momentum wheel 212 is illustrated as rotating clockwise and the momentum wheel 214 is illustrated as rotating counterclockwise. Similarly, the momentum wheel 216 is illustrated as rotating clockwise and the momentum wheel 218 is illustrated as rotating counterclockwise.

Opposite rotation of the momentum wheels 212 and 214 as shown in FIG. 2 at equal speeds generally results in all momentum produced thereby being canceled. As a result, in such a case, no momentum is transferred to the spacecraft 100 as a result of the rotation of the momentum wheels 212 and 214 in this manner. Likewise, opposite rotation of the momentum wheels 216 and 218 as shown in FIG. 2 at equal speeds generally results in all momentum produced thereby being canceled. Therefore, in such a case, no momentum is transferred to the spacecraft 100 as a result of the rotation of the momentum wheels 216 and 218 in this manner. Thus, the momentum wheels 212 and 214 and the momentum wheels 216 and 218 may each be considered to together form a momentum-canceling set.

The momentum-wheel configuration 200 is presented only as an example to illustrate various technical principles. One of ordinary skill in the art will note that more or fewer momentum wheels may be utilized, for example, to provide redundancy or additional control of a spacecraft such as, for example, the spacecraft 100. Additionally, momentum wheels may be arranged at various angles (e.g., non-parallel) relative to the pitch axis 104, the yaw axis 102, and the roll axis 106 in order to facilitate advantageous slew of a spacecraft such as, for example, the spacecraft 100. Further, although the momentum-wheel configuration 200 illustrated in FIG. 2 includes only two momentum-canceling sets, it should be noted that, in various embodiments, similar objectives may also be achieved via a single momentum-canceling set or any other integral number of momentum-canceling sets.

In various embodiments, the spacecraft 100 may be required to slew to an orientation so that, for example, the viewing device 108 can observe an event at a particular location in space. The event may be a sporadically-occurring event such as, for example, a Gamma-ray burst. In a typical embodiment, rather than beginning rotation responsive to occurrence of an event, the momentum wheels 212, 214, 216, and 218 may rotate prior to or in between slews of the spacecraft 100.

More particularly, as a momentum-canceling set, the momentum wheels 212 and 214 are operable to appropriately rotate at momentum-canceling speeds prior to or in between slews of the spacecraft 100. For example, the momentum wheel 214 may rotate as shown in FIG. 2 in a clockwise direction at a speed that aims to cancel momentum produced by rotation of the momentum wheel 212 in a counterclockwise direction. In a similar manner, as a momentum-canceling set, the momentum wheels 216 and 218 are operable to appropriately rotate at momentum-canceling speeds prior to or in between slews of the spacecraft 100. For example, the momentum wheel 216 may rotate in a clockwise direction at a speed that aims to cancel momentum produced by rotation of the momentum wheel 218 in a counterclockwise direction. In that way, the momentum wheels 212, 214, 216, and 218 may each be caused to rotate in efforts to prevent transfer of momentum to the spacecraft 100.

In the momentum-wheel configuration 200, the momentum-canceling speeds may be, for example, equal speeds. However, in a typical embodiment, an orientation of a spacecraft such as, for example, the spacecraft 100, is constantly measured via a gyroscope. Therefore, the momentum-canceling speeds may be adjusted in real time, for example, to offset any external forces that cause slew of the spacecraft 100. A rate at which the momentum wheels 212, 214, 216, and 218 accelerate to the momentum-canceling speeds may be adjusted in a similar manner in efforts to prevent transfer of momentum when rotational speed is being increased. In a typical embodiment, rotation of the momentum wheels 212, 214, 216, and 218 may be accelerated to particular momentum-canceling speeds, for example, over a period of time, so that the requisite input power is low. Therefore, rotation of the momentum wheels 212, 214, 216, and 218 may be accelerated using less than all available power. Various illustrative advantages will be discussed in further detail below.

Upon the occurrence of an event such as, for example, a Gamma-ray burst, a location in the sky may be identified and a slew of the spacecraft 100 may be required. In a typical embodiment, one or more momentum wheels from each momentum-canceling set may be braked in order to initiate slew. For example, the momentum wheel 212 or the momentum wheel 214 may be braked to cause slew of the spacecraft 100 about the pitch axis 104. In like manner, the momentum wheel 216 or the momentum wheel 218 may be braked to cause slew about the yaw axis 102. If a large slew angle is required about a particular axis, an appropriate momentum wheel may be braked to a stop so that the spacecraft 100 slews faster. In various embodiments, braking may be implemented, for example, mechanically or electronically. One of ordinary skill in the art will appreciate that power required to apply braking to momentum wheels is oftentimes significantly lower than power required to accelerate rotation of momentum wheels.

In this manner, the spacecraft 100 may be caused to slew in a controlled fashion oppositely to the rotation of non-braked momentum wheel(s). Shortly before the spacecraft 100 arrives at a desired orientation, one or more of the momentum wheels 212, 214, 216, and 218 that are in rotation may be braked to a stop. Responsive to one or more of the rotating momentum wheels 212, 214, 216, and 218 having been braked, the spacecraft 100 stops slewing, points at approximately the desired orientation, and returns to an approximately zero-momentum state.

In various embodiments, the spacecraft 100 achieves a maximum angular velocity in a desired direction via, for example, rotation of the momentum wheels 212, 214, 216, and 218 at maximum-rated speeds. In a typical embodiment, the momentum-canceling speeds for the momentum-wheel configuration 200 discussed above may be the maximum-rated speeds of the momentum wheels 212, 214, 216, and 218. As a result of the momentum wheels 212, 214, 216, and 218 rotating at maximum-rated speeds, a maximum-rated momentum may be transferred to the spacecraft 100 upon initiation of the slew via braking of appropriate ones of the momentum wheels 212, 214, 216, and 218. Following completion of the slew, the momentum wheels 212, 214, 216, and 218 may again be rotated at momentum-canceling speeds (e.g., maximum-rated speeds) in preparation for a subsequent slew. As before, the momentum wheels 212, 214, 216, and 218 may be rotationally accelerated gradually in order to minimize power required to reach maximal rotational speed. For example, the momentum wheels 212, 214, 216, and 218 may be accelerated using far less than all available power.

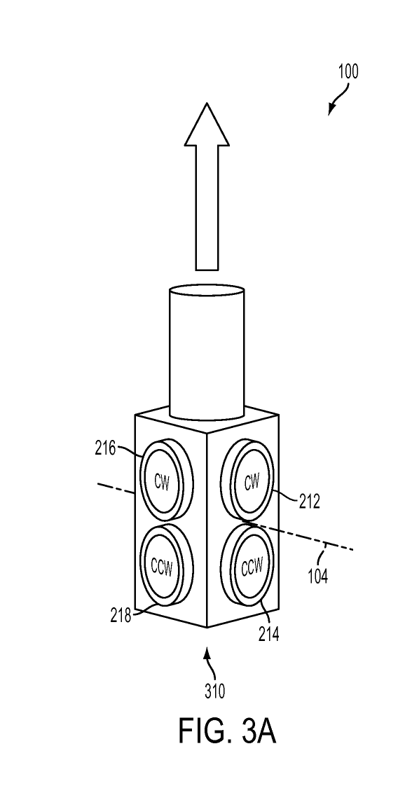

FIGS. 3A and 3B show an illustrative slew of the spacecraft 100 about the pitch axis 104. FIG. 3A illustrates the spacecraft 100 with an initial orientation 310. FIG. 3B illustrates the spacecraft 100 at a modified orientation 320. At the modified orientation 320, the spacecraft 100 has rotated 50 degrees about the pitch axis 104 relative to the initial orientation 310.

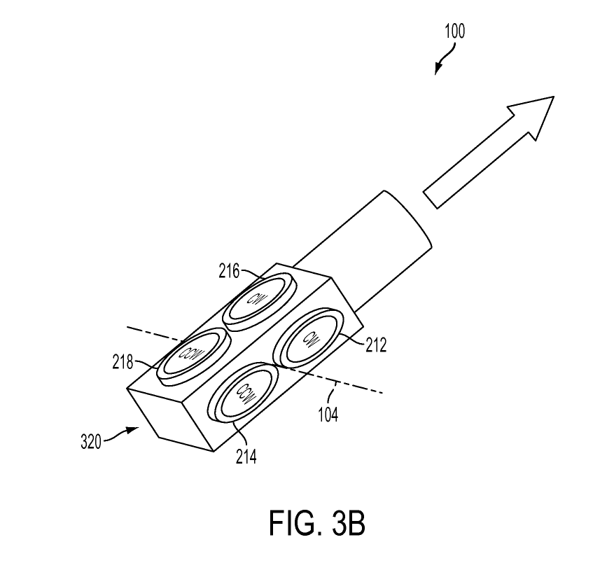

FIG. 4 is a graph 400 that plots slew time against slew angle. In particular, the graph 400 compares slew time for rotation about a particular axis of a prior-art configuration 404 and a new configuration 402 such as, for example, the momentum-wheel configuration 200 illustrated in FIG. 2. The prior-art configuration 404 utilizes a single momentum wheel positioned to rotate parallel to the particular axis. In the prior-art configuration 404, the single momentum wheel is accelerated to its maximum-rated speed upon initiation of slew at 0 seconds. The new configuration 402 utilizes two momentum wheels that, at 0 seconds, are oppositely rotating parallel to the particular axis at maximum-rated speeds of the momentum wheels. The two momentum wheels may be, for example, similar to the momentum wheels 212 and 214.

Data for the new configuration 402 is based on calculations derived from the prior-art configuration 404. For example, the data for the new configuration 402 is calculated by adjusting the data for the prior-art configuration 402 to reflect, inter alia, projected braking speed and projected differences in momentum-wheel speeds. The graph 400 illustrates a substantial improvement in slew speed of the new configuration 402 compared to the prior-art configuration 404. For example, the prior-art configuration 404 achieves a 50-degree slew in approximately 85 seconds, while the new configuration 402 achieves a 50-degree slew in approximately 35 seconds.

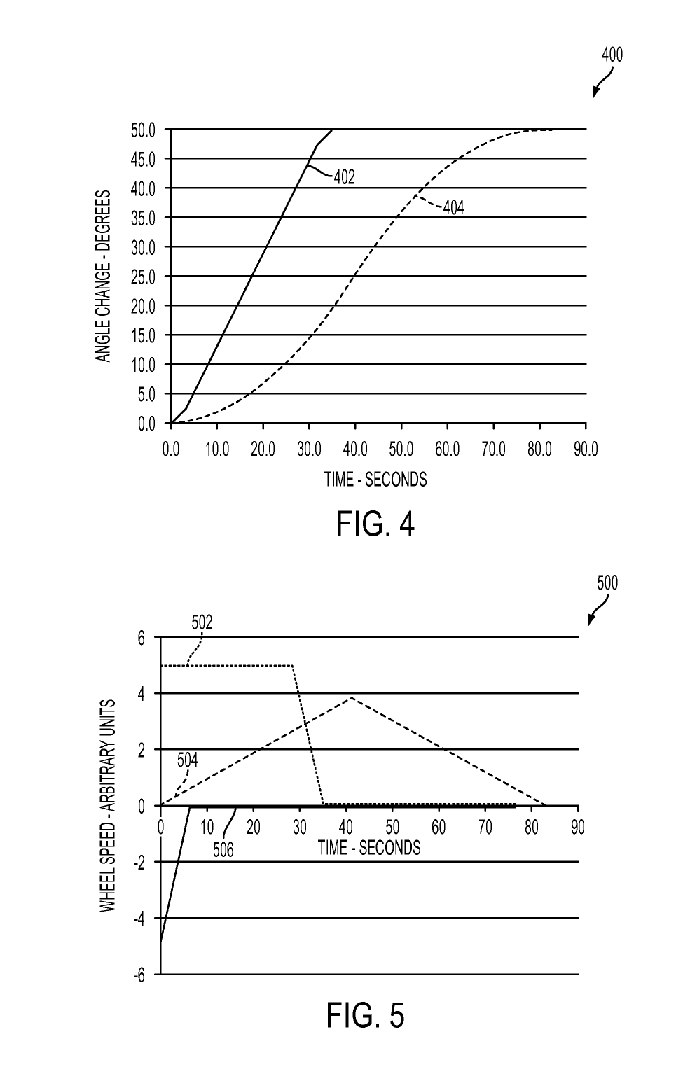

FIG. 5 is a graph 500 that illustrates a time to achieve a 50-degree slew about one axis. The graph 500 plots a momentum wheel 502, a momentum wheel 504, and a momentum wheel 506. The momentum wheel 502 and the momentum wheel 506 are, for example, similar to the two momentum wheels in the new configuration 402 of FIG. 4. The momentum wheel 504 is, for example, similar to the single momentum wheel of the prior-art configuration 404 of FIG. 4. For purposes of illustration, a maximum-rated rotational speed of each of the momentum wheel 502, the momentum wheel 504, and the momentum wheel 506 is assumed to be five arbitrary units. As discussed with respect to the graph 400, data for the momentum wheels 502 and 506 is calculated by adjusting the data for the prior-art configuration 402 to reflect, inter alia, projected braking speed and projected differences in momentum-wheel speeds.

As shown in the graph 500, the momentum wheel 504 does not reach its maximum-rated speed. The momentum-wheel 504 is accelerated at 0 seconds using all available power. However, the momentum wheel 504 has only achieved a rotational speed of four arbitrary units at approximately 40 seconds when the momentum-wheel 504 must be braked so that a spacecraft such as, for example, the spacecraft 100, stops slewing at approximately the 50-degree slew. The momentum wheel 504 thus accomplishes the 50-degree slew in approximately 85 seconds.

Conversely, prior to 0 seconds on the graph 500, the momentum wheel 502 and the momentum wheel 504 are oppositely rotating at the maximum-rated speed of five arbitrary units. At 0 seconds, the momentum wheel 506 is braked to a stop in order to initiate the 50-degree slew. By approximately 5 seconds, the momentum wheel 506 is stopped while the momentum wheel 502 continues to rotate at the maximum-rated speed. At approximately 30 seconds, the momentum wheel 502 is braked so that a spacecraft, such as, for example, the spacecraft 100, stops at approximately the 50-degree slew. By approximately 35 seconds, the momentum wheel 502 is stopped and a spacecraft such as, for example, the spacecraft 100, stops slewing at approximately the 50-degree slew. The momentum wheel 502 and the momentum wheel 506 thus collaborate to accomplish the 50-degree slew in approximately 35 seconds.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A method comprising:
providing two or more momentum wheels arranged for rotation on a spacecraft in a momentum-canceling set;
causing the two or more momentum wheels in the momentum-canceling set to rotate at momentum-canceling speeds; and
reducing rotational speed of a momentum wheel in the momentum-canceling set to initiate a slew of the spacecraft.

2. The method of claim 1, the method comprising braking rotating ones of the two or more momentum wheels to complete the slew.

3. The method of claim 2, comprising repeating the causing in preparation for a subsequent slew.

4. The method of claim 1, wherein the reducing is responsive to an event external to the spacecraft.

5. The method of claim 1, wherein:
the two or more momentum wheels rotate about parallel axes; and
the causing comprises causing the two or more momentum wheels to oppositely rotate.

6. The method of claim 5, wherein the two or more momentum wheels in the momentum canceling set rotate about an axis parallel to one of a yaw axis of the spacecraft and a pitch axis of the spacecraft.

7. The method of claim 1, wherein the causing comprises accelerating the two or more momentum wheels in the momentum-canceling set to maximum-rated speeds of the two or more momentum wheels.

8. The method of claim 5, the method comprising:
wherein the providing comprises providing two or more momentum wheels arranged for rotation on the spacecraft in a second momentum-canceling set;
wherein the causing comprises causing the two or more momentum wheels in the second momentum-canceling set to rotate at momentum-canceling speeds; and
wherein the reducing comprises reducing rotational speed of at least one momentum wheel in the second momentum-canceling set.

9. The method of claim 1, wherein the causing comprises accelerating the two or more momentum wheels using less than all available power.

10. The method of claim 1, wherein the reducing comprises braking a momentum wheel of the two or more momentum wheels to a stop.

11. The method of claim 5, wherein:
the two or more momentum wheels in the second momentum-canceling set rotate about parallel axes; and
the causing comprises causing the two or more momentum wheels in the second momentum-canceling set to oppositely rotate.

12. The method of claim 11, wherein:
the two or more momentum wheels in the momentum-canceling set rotate about an axis parallel to a pitch axis of the spacecraft; and
the two or more momentum wheels in the second momentum-canceling set rotate about an axis parallel to a yaw axis of the spacecraft.

13. A momentum-wheel configuration for a spacecraft, the momentum-wheel configuration comprising two or more momentum wheels arranged for rotation on the spacecraft in a momentum-canceling set.

14. The momentum-wheel configuration of claim 13, the momentum-wheel configuration comprising a braking mechanism coupled to each of the two or more momentum wheels in the momentum canceling set and that reduces rotational speed of the two or more momentum wheels.

15. The momentum-wheel configuration of claim 13, wherein the two or more momentum wheels are arranged on the spacecraft for rotation on parallel axes.

16. The momentum-wheel configuration of claim 15, wherein the two or more momentum wheels are arranged for rotation about an axis parallel to one of a yaw axis and a pitch axis of the spacecraft.

17. The momentum-wheel configuration of claim 15, comprising two or more momentum wheels arranged for rotation on the spacecraft in a second momentum-canceling set.

18. The momentum-wheel configuration of claim 17, wherein the two or more momentum wheels in the second momentum-canceling set are arranged for rotation on parallel axes.

19. The momentum-wheel configuration of claim 18, wherein:
the two or more momentum wheels in the momentum-canceling set are arranged for rotation about an axis parallel to a pitch axis of the spacecraft; and
the two or more momentum wheels in the second momentum-canceling set are arranged for rotation about an axis parallel to a yaw axis of the spacecraft.

20. The momentum-wheel configuration of claim 18, the momentum-wheel configuration comprising a braking mechanism coupled to each of the two or more momentum wheels in the second momentum-canceling set and that reduces rotational speed of the two or more momentum wheels in the second momentum-canceling set.
